(19) United States
(12) Patent Application Publication
(10) Pub. No.: US 2004/0115605 A1
(43) Pub. Date: Jun. 17, 2004

(54) Apparatus and method for assessing psychological state

(76) Inventor: Richard Charles Gordon Cooper, Toronto (CA)

Correspondence Address: Cynthia J. Ledgley,, Barrister & Solicitor, Patent & TM Agent, Suite 1000, (10th Floor), 121 Richmond St. West, Toronto, ON, M5H 2K1, CA

(21) Appl. No.: 10/730,990

(22) Filed: Dec. 10, 2003

Related U.S. Application Data
(60) Provisional application No. 60/432,008, filed on Dec. 10, 2002.

(51) Int. Cl. G09B 19/00

(52) U.S. Cl. 434/236; 600/300

(57) ABSTRACT

This invention relates to an apparatus, and a method of using the apparatus, which assists individuals in measuring and assessing, the impact of life events or life experiences on their state of mind and/or their quality of life.

### FIELD OF THE INVENTION

This invention relates to an apparatus, and a method of using the apparatus, which assists individuals in measuring and assessing, the impact of life events or life experiences on their state of mind and/or their quality of life. The invention further relates to an apparatus, and a method of using the apparatus, to measure over a period of time, life events or life experiences arising from personal relationships. The invention further relates to assessing how ongoing life events or experiences affect an individual, either positively or negatively. The invention further relates to means for measuring over time a series of such events or experiences to assist an individual, or individuals, in making life decisions and choices.

### BACKGROUND OF THE INVENTION

Most individuals are unaware of their unconscious feelings. This lack of conscious awareness can impact on an individual's ability to understand certain stressors in their lives. Often an individual is aware of physical stress by certain physical manifestations and yet does not understand the factors which are contributing to the manifestations.

Stress can be corrosive to a person's psyche and ability to cope. In the absence of lengthy and expensive psychological counseling which often is not available or practical in all instances, there is a need for other devices and/or methods to assist individuals in understanding their stresses by bringing their feelings to the surface and becoming more consciously aware of them.

An apparatus which helps to relieve stress and to allow an individual to quantify in relative terms the impact that certain stresses are having on them in their personal lives and careers assists these individuals in working out problems and taking appropriate actions to address certain situations.

### SUMMARY OF THE INVENTION

In accordance with an aspect of the present invention, there is provided an apparatus for assessing psychological state, the apparatus comprising,

a measurement device, the measurement device comprising a scale defining a range of values and an indicator to mark a position on said scale; and

a manual, the manual comprising instructions for the use of the device and the manual further comprising a written description of a series of events or experiences each of which is assigned a value.

In another aspect the apparatus measurement device of the present invention comprises a support means comprising the scale defining a range of values.

In accordance with another aspect of the present invention, the apparatus comprises a support means and a base such that the apparatus is free standing. In accordance with another aspect of the present invention, there is provided a means to mount said device on a wall.

In accordance with another aspect of the present invention, the scale of values on the device is either quantitative such as a graduated numerical scale, or it is qualitative such as pictures or other images which depict a range of emotions or other psychological outcomes.

In accordance with another aspect of the present invention there is provided an indicator on said device which can be positioned at any one of the values in the scale of values on the device. The indicator may be a series of stickers or it could be an indicator finger which is repositionable from one position to another.

The apparatus and methods of the present invention are provided to assist one or more individuals in a relationship to assess the impact of that relationship on the individual's personal state of mind. In accordance with another aspect of the present invention the apparatus and methods of the present invention assists the individual or individuals in assessing the impact of certain life events or experiences on their own quality of life. In yet another aspect of the present invention, the apparatus and methods of the present invention provide qualitative and/or quantitative guidance to the individual or individual such that they are able to determine if they should take certain steps or act based on the results achieved.

In accordance with another aspect of the present invention the relationship between the individuals is selected from a variety of relationships groupings. Some examples include, inter-personal relationships, family relationships, parent-child relationships, employment relationships, and employee-employer relationships.

In accordance with another aspect of the present invention there is provided a manual to be used together with the device. In one embodiment, the manual lists a series of events suitable for the relationship which is being assessed by the individual, or individuals. Different manuals may be prepared for different types of relationships and provide scenarios or descriptions of events or experiences depending on the type of relationship. In accordance with a preferred embodiment of the present invention, the manual lists or describes a series of life events or life experiences which may occur in a particular type of relationship and each such event or experience is assigned a value.

In one embodiment of the present invention, the assigned values are relative values with respect to a baseline. The individual can use these values and descriptions as guidelines against which actual life events or experiences may be compared and then choose a value for the specific event. This value is then translated into an amount by which an indicator is moved on the device to reflect a better or worse psychological state or outcome for the individual or individuals. As these events and experiences occur the indicator is moved thereby acting as a physical means to summarize in a real and authentic way the events of their life in order to assess whether certain decisions should be made.

In accordance with another aspect of the present invention there is provided a method of using the device of the present invention together with a manual. The method comprises in one preferred embodiment the steps of:

a) setting the indicator to an initial position on the device,

b) upon the individual experiencing an actual event or actual experience, the individual referring to the manual and determining which of the listed events or experiences in the manual most closely correlates to the actual event or actual experience

c) determining the value for the event or experience based on the list of events or experiences in the manual,

d) moving the indicator from the initial position based on the score for that event or experience thereby setting the indicator to a next position,

e) upon the individual experiencing a subsequent actual event or experience, the individual referring to the manual and determining which of the listed events or experiences in the manual most closely correlates to the actual event or actual experience,

f) determining the value for the subsequent actual event or experience based on the list of events or experiences in the manual,

g) moving the indicator from the next position to a new next position based on the score for that event or experience thereby setting the indicator to a new next position,

h) repeating steps e) to g) over a period of time defined by the individual.

### BRIEF DESCRIPTION OF THE DRAWINGS

Other and further advantages and features of the invention will be apparent to those skilled in the art from the following detailed description of the preferred embodiments of the invention taken together with the accompanying drawings.

For the purpose of illustrating the invention, there is shown in the drawings a form which is presently preferred; it being understood, however, that this invention is not limited to the precise arrangements and instrumentalities shown. Like reference numerals refer to like parts.

In the accompanying drawings:

FIG. 1 illustrates one embodiment of the present invention illustrating a stand alone device; and,

FIG. 2 illustrates a second embodiment of the present invention illustrating the device in another format as a stand alone device.

### DETAILED DESCRIPTION OF THE INVENTION

The present invention provides an apparatus and method for assessing psychological state of an individual or a group. The apparatus and methods of the present invention are suitable for use in a variety of life situations and circumstances.

The apparatus and methods of the present invention assist an individual, either on their own or with the assistance of a counselor, to become more aware of their feelings and psychological states of mind in response to life stressors, events and experiences. The apparatus and methods of the present invention are suitable for assessing job satisfaction, marital satisfaction, parental discipline or other activities which are impacting on the psychological state of the individual or for which a series of events or experiences may drive the individual to choose a particular decision which would affect that relationship and/or their own personal health.

Mental health professionals identify that when a person is stressed they need to focus on working out problems in a grounded fashion based on reality rather than wishful fantasy. The apparatus and methods of the present invention assist by providing a graduated scale and assessment manual by which the user of the device is able to quantify in relative terms various stressful events which may be occurring in their life.

The apparatus and methods of the present invention help to bring to consciousness and to the surface feelings which this individual would otherwise have been only marginally aware. There are a variety of ways through which a person can come to this awareness and the apparatus and methods of the present invention provide a simple and affordable tool which individuals may use in their daily life and keep in their home or at their workplace.

The manual accompanying the device of the present invention is an instruction guide or could also be considered an assessment manual and it sets out concrete and real examples of events or experiences which may occur in a particular relationship setting such as a workplace, a family or a marriage. The events are ranked and scored based on whether they cause greater or less stress, happiness or other emotional outcome in that relationship. In another embodiment, the manual may set out positive or negative scores indicating whether the individual is closer or further away from a particular end event or final result.

The manual accompanying the device of the present invention is an instruction guide or could also be considered an assessment manual and it sets out concrete and real examples of events or experiences which may occur in a particular relationship setting such as a workplace, a family or a marriage. The events are ranked and scored based on whether they cause greater or less stress, happiness or other emotional outcome in that relationship. In another embodiment, the manual may set out positive or negative scores indicating whether the individual is closer or further away from a particular end event or final result.

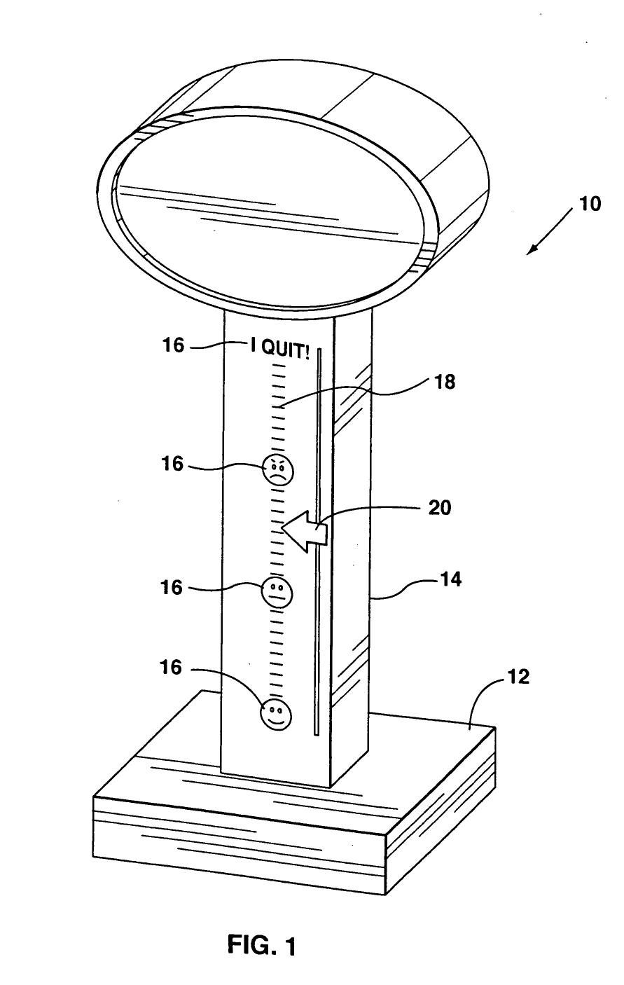

One embodiment is exemplified in FIG. 1. FIG. 1 is an example of the present invention in an employment situation which may be used by an employee. The apparatus 10 comprises a base 12, a support means 14, indicia 16 on the support means identifying particular psychological states and metered gradations 18 defining ranges in a scaled or metered manner. A re-positionable indicator means 20 is located on the support means to point to a particular graduation thereby providing a visual means for the employee to identify whether they are closer or further away from the ultimate event of quitting their job.

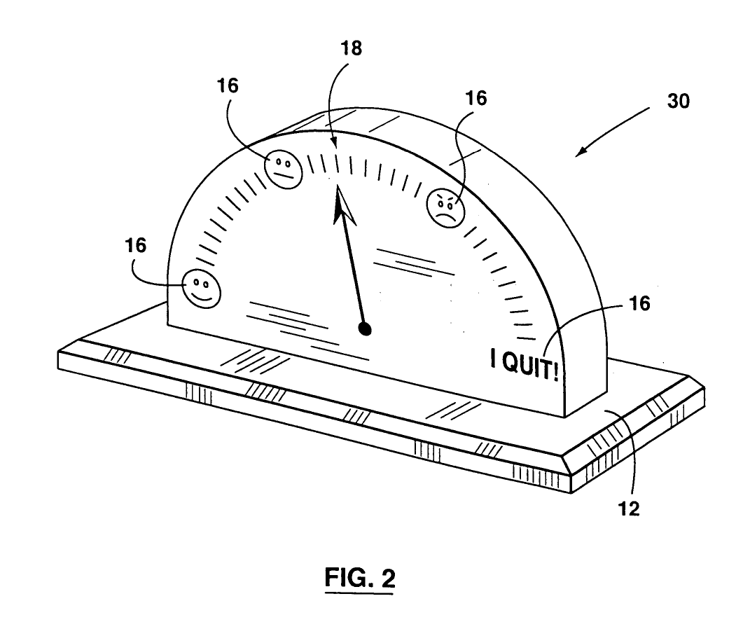

Although FIG. 1 illustrates the present invention as a free-standing vertical apparatus 10, the apparatus of the present could be configured in a semi-circular fashion with a central indicator with the indicia identified along the circumference of the device 30 as is illustrated in FIG. 2. In another embodiment the apparatus could be designed to hang on a wall or mounted in your car or designed with a magnet so that it can adhere to a metal surface such as a refrigerator.

In an employment situation the psychological state assessed by the apparatus and methods of the present invention may be defined by whether to quit your job or not. In the embodiments illustrated in FIGS. 1 and 2 the uppermost limit of the scale is “I quit” and the scale is marked both in graduations 18 as well as visual pictures identifying a particular state of mind. In other situations similar devices may be applied to romantic relationships (to commit or to leave) and parent-child disciplinary matters (to discipline or not) and be equally beneficial.

The values assigned to a particular life event or experience are, in one embodiment, relative to one another. It is conceivable that a particular psychological scale may be devised that is quantitative.

Much frustration, depression, bitterness and anger is caused by people not knowing exactly how they feel in or about various situations, and that lack of connection with their feelings leads to either inaction—an inability to make a decision—or inappropriate responses, such as angry outbursts or destruction of property. The apparatus and methods of the present invention provide a direct and immediate reflection of changing moods and feelings. As such this can give the individual more control over situations which are occurring and also more insight, thereby creating a more productive and harmonious environment.

In a workplace environment, the device of the present invention assists individuals in monitoring their level of workplace frustration. It allows individuals to evaluate when and if they should quit their job by helping them quantify their job satisfaction or dissatisfaction. It helps individuals to deal with workplace stress by giving them a tangible way to express their level of frustration. It is a good and positive alternative to verbally complaining without defining the specific sources of concern.

The apparatus and methods of the present invention, in one embodiment, provide means of measuring and visually demonstrating how close someone is to quitting their job. It helps the individual preserve their own mental health by helping them cognitively recognize exactly how psychologically distressed their job is making them and how close they are psychologically to quitting their job.

As a visual, physical representation of their emotional state the individual is able to process in a real way the circumstances of their situation thereby reducing psychological stress. Frustration and anxiety are reduced by assisting individuals in tracking their emotional psychological state throughout the day, as it pertains to certain frustrations and anxieties. The accompanying manual provides guidance as to the events which occur and quantifies the events based on seriousness and the expected impact on an individual's psychological health. The manual could also serve as a workbook.

In a workplace environment the present invention assists an individual in determining when “enough is enough” and that some action is required to preserve the person's health or state of mind. In a workplace or marriage situation the measurement may be one of happiness or unhappiness and as such the device assists individuals with making personal decisions and choices whether to leave a bad environment by visually, cognitively acknowledging that person's unhappiness. In this way the apparatus and methods of the present invention assist an individual or individuals in measuring the progress that they are making in terms of attaining more satisfaction in their relationship. The apparatus and methods of the present invention therefore can reinforce positive events and experiences as well as make the individual aware of an accumulation of negative or stressful events in their life.

In some instances the present invention may even allow individuals to realize that they can or must make a decision with respect to the course of events in their life. For example, as a series of life events occurred an individual would move the indicator on the device based on the value they assign to the event. If the indicator continues to move in a negative direction the individual would be more cognitively aware that based on the result that they have the option to choose to quit a particular relationship. Extreme unhappiness would be a good reason to stop working for a particular person or company, for example, but often the person is “on a treadmill” and they think the job might get better without having any way of assessing whether they are correct. The present invention therefore provides further information to the individual to assist them in better understanding their current position and raises their cognitive awareness of the situation.

In a workplace environment, the assessment manual permits employees to calculate using a relative scale whether certain negative workplace experiences, for example being demeaned by one's boss in front of co-workers, justifies quitting their job either alone or when taken in combination with other life or work events. In this way the present invention permits individuals, either alone or with the assistance of a counselor, to chart their workplace or personal satisfaction, or lack thereof, and measure the significance of specific pleasant and/or unpleasant events that occur over a period of time defined by the individual.

The apparatus and methods of the present invention are designed to be fun to use. The apparatus and methods of the present invention are energizing for the individual and draw the individual into actually using the apparatus. Even though it is designed to be fun and entertaining, it is still an effective tool to achieve a genuine result. The fact that the person can use the device in a fun and entertaining manner assists in its effectiveness and enjoyment. Humor may be used in the descriptions of the manual and the lists in the manual to disperse the stress encountered by the individual and encourage them to use the device in a positive way.

The situations for which the apparatus and methods of the present invention may be used can vary from relationship to relationship. In all types of relationships, however, the individual or individuals identify directions the relationship is taking and identify when further steps may need to be taken by the individual to have less stress in their life and achieve greater happiness.

In an example of one use of the present invention, with reference to FIG. 1, an individual begins with the device 10 sitting on their desk at their place of work. The re-positionable indicator 20 is set to a zero position or mid-way position on the scale of graduations 18. This mid-way position is illustrated by the position of the indicator 20 in FIG. 1. When an event occurs, for example an event listed in Example 1 below, the person turns to the reference manual and looks for a description that most closely matches that event. Next to the description there is a value which the person then identifies. For example, “work all weekend +2”. The person then moves the re-positionable indicator up the scale 2 gradations closer towards the top of the device, or closer to the words “I quit”. The next day the individual calls in sick and gets away with it. When the person returns to work they would look for the description most closely matching this event and determine the score affiliated with that event. Looking at Example 1, for example, the manual states “You call in “sick” and get away with it −2”. The individual would then lower the re-positionable indicator two gradations thereby moving the indicator further away from the words “I quit”, and so on in similar fashion as various events occur. If an event or experience occurred for which there was no appropriate description the person could insert their own description into the manual and assign a value accordingly. If an event was similar, although not exact, a similar value could be selected.

The following examples are provided only to exemplify the invention and are not intended to limit the invention to only the scope of the examples. The invention is as defined in accordance with the words and spirit of the appended claims which follow.

All references cited herein are fully incorporated by reference.

### EXAMPLES

### Example 1

The following is an example of the types of descriptions and values that could be included in the manual of the present invention in an employment relationship but the invention is not limited to these specific descriptions rather the example is intended to exemplify one embodiment of the invention thereby enabling an understanding of other similar embodiments and equivalents which would fall within the scope of the invention as claimed.

Descriptions and Values:

Closer to Quit

Work all weekend +2

Demeaned by boss in front of co-workers +5

Miss Social Engagement +1

Passed over for promotion +5

Co-worker has annoying laugh +2

Unwanted sexual attention +3

Forced to attend “Brain storming” session +1

Client kills good idea for personal reasons +3

You have dream about work +1

Computer Problem +1

You get assigned office “Joe Job”+2

You realize your client is about as smart as a cocker spaniel +3

You dial “9” first before making a call, at home +1

You realize your boss is in fact the antichrist +2

You get blamed for something that wasn't your fault +3

You get blamed for something that WAS your fault +1

Further from Quit

Raise −5

you have a night out on the company −2

You call in “sick” and get away with it −2

You spend all morning reading personal emails −1

“free” stationary for home −1

Attractive co-worker moves into next cubicle −3

Promotion—you decide if that's good or bad + or −5

moved to better office −3

Wanted sexual attention −3

Pillage free lunch from meeting you didn't attend −1

Box Seats −3

Juicy office scandal keeps you entertained for a day −1

Christmas bonus −2

Your boss displays human emotion or thanks you −3

You totally screw up and someone else gets blamed −2

Although preferred embodiments of the invention have been described herein, it will be understood by those skilled in the art that variations, modifications and equivalents may be made without departing from the spirit or scope of the invention as defined in the appended claims.

What is claimed is:

1. An apparatus for assessing psychological state, the apparatus comprising,
a measurement device, the measurement device comprising a scale defining a range of values and an indicator to mark a position on said scale; and
a manual, the manual comprising instructions for the use of the device and the manual further comprising a written description of a series of events or experiences each of which is assigned a value.

2. The apparatus according to claim 1 wherein said measurement device further comprises a support means comprising the scale defining a range of values.

3. The apparatus according to claim 2 wherein said device further comprises a stand alone base.

4. The apparatus according to claim 2 wherein said device is mountable on a wall.

5. The apparatus according to claim 2 wherein said scale is a graduated numerical scale.

6. The apparatus according to claim 2 wherein said scale is not numerical.

7. The apparatus according to claim 2 wherein said scale is a combination of numerical and non-numerical indicia.

8. The apparatus according to claim 2 wherein said indicator is re-positionable.

9. The apparatus according to claim 2 wherein said series of events or experiences are events or experiences arising from a relationship.

10. The apparatus according to claim 2 wherein the relationship is selected from the group of relationships consisting of personal relationships, family relationships, parent-child relationships, employment relationships, employee-employer and relationships.

11. The apparatus according to claim 2 wherein a value assigned to said events or experiences in said manual correlates to the scale of values on said device.

12. The apparatus according to claim 11 wherein said manual further comprises a description of a set of options based on totaling the values of a plurality of events or experiences.

13. A method of using a device according to claim 1 to measure the psychological state of an individual, the method comprising the steps of:
a) setting said indicator to an initial position on said device.
b) upon the individual experiencing an actual event or actual experience, said individual referring to said manual and determining which of the listed events or experiences in said manual most closely correlates to said actual event or actual experience,
c) determining the value for said event or experience based on the list of events or experiences in said manual,
d) moving said indicator from said initial position based on the score for that event or experience thereby setting the indicator to a next position,
e) upon the individual experiencing a subsequent actual event or experience, said individual referring to said manual and determining which of the listed events or experiences in said manual most closely correlates to said actual event or actual experience,
f) determining the value for said subsequent actual event or experience based on the list of events or experiences in said manual,
g) moving said indicator from said next position to a new next position based on the score for that event or experience thereby setting the indicator to a new next position,
h) repeating steps e) to g) over a period of time defined by said individual.

14. The method according to claim 13 wherein the value selected is a qualitative value.

15. The method according to claim 13 wherein the value selected is a quantitative value.

16. A method of using a device according to claim 2 to measure the psychological state of an individual, the method comprising the steps of:
a) setting said indicator to an initial position on said device.
b) upon the individual experiencing an actual event or actual experience, said individual referring to said manual and determining which of the listed events or experiences in said manual most closely correlates to said actual event or actual experience,
c) determining the value for said event or experience based on the list of events or experiences in said manual,
d) moving said indicator from said initial position based on the score for that event or experience thereby setting the indicator to a next position,
e) upon the individual experiencing a subsequent actual event or experience, said individual referring to said manual and determining which of the listed events or experiences in said manual most closely correlates to said actual event or actual experience,
f) determining the value for said subsequent actual event or experience based on the list of events or experiences in said manual,
g) moving said indicator from said next position to a new next position based on the score for that event or experience thereby setting the indicator to a new next position,
h) repeating steps e) to g) over a period of time defined by said individual.

17. The method according to claim 16 wherein the value selected is a qualitative value.

18. The method according to claim 16 wherein the value selected is a quantitative value.
